(19) United States
(12) Patent Application Publication
(10) Pub. No.: US 2011/0076441 A1
(43) Pub. Date: Mar. 31, 2011

(54) SEMI-FINISHED PRODUCT AND SEMI-FINISHED PRODUCT COMPOSITE

(75) Inventors: Jan GRUENERT, Chemnitz (DE); Hans-Juergen HEINRICH, Roehrsdorf (DE)

(73) Assignee: KARL MAYER MALIMO TEXTILMASCHINENFABRIK GMBH, Chemnitz (DE)

(21) Appl. No.: 12/712,684

(22) Filed: Feb. 25, 2010

(30) Foreign Application Priority Data
Sep. 29, 2009 (DE) 10 2009 043 280.9

(51) Int. Cl. B32B 5/12; B32B 17/02; B32B 9/00; B32B 18/00; B32B 27/34; B32B 27/02; B32B 27/32; B32B 37/00; B32B 38/18; B32B 43/00

(52) U.S. Cl. 428/113; 428/426; 428/408; 428/448; 428/474.4; 428/523; 428/704; 428/411.1; 156/60; 156/184; 156/563; 156/443

(57) ABSTRACT

Semi-finished product, semi-finished product composite formed from semi-finished product, and method and apparatus for forming the semi-finished product. The semi-finished product includes reinforcing fibers and two layers of thermoplastic material. The reinforcing fibers are arranged between the two layers of thermoplastic material.

### CROSS-REFERENCE TO RELATED APPLICATIONS

The present application claims priority under 35 U.S.C. §119 of German Patent Application No. 10 2009 043 280.9 filed on Sep. 29, 2009, the disclosure of which is expressly incorporated by reference herein in its entirety.

### BACKGROUND OF THE INVENTION

1. Field of the Invention

The invention relates to a semi-finished product with plastic and reinforcing fibers. Furthermore, the invention relates to a semi-finished product composite.

2. Discussion of Background Information

Components of fiber-reinforced plastic are used in many fields of technology. Components of fiber-reinforced plastic have the advantage over metal components, of higher specific mechanical properties. Furthermore, plastics can also be used in areas where metals would corrode.

In order to produce a component of a fiber-reinforced plastic, the reinforcing fibers are generally placed in a mold and the plastic is then inserted. The plastic then forms a matrix that is reinforced by the reinforcing fibers. Although many components can be produced therewith, a subsequent shaping of components of this type is generally possible only with great difficulty.

For this reason, metal sheets are still used as semi-finished products to produce certain components. Metal sheets of this type can be worked, for example, by deep drawing. However, a deep drawn construction element from a metal sheet, for example, a component of a motor vehicle body, can be replicated with a corresponding construction element of plastic only at considerable expenditure.

### SUMMARY OF THE INVENTION

Embodiments of the invention provide a fiber reinforced plastic semi-finished product with largely universal application.

According to embodiments, a semi-finished, product of the type mentioned at the outset includes reinforcing fibers arranged between two layers of thermoplastic material.

As a semi-finished product of this type can be shaped, in certain cases, in a manner similar to metal sheets, it can form an alternative to sheet metal. Thermoplastic material can be shaped, if necessary, with heat application, e.g., by deep drawing. In shaping of this type, the reinforcing fibers remain between the layers of the thermoplastic material, and therefore are protected from exposure to effects from the environment. The plastic layers in turn keep the reinforcing fibers in their position. No fiber breakages or at least few fiber breakages occur, so that the tensile strength is maintained in the main direction in which the reinforcing fibers run, even after a shaping. As soon as the thermoplastic plastic has cooled, the deformed semi-finished product is dimensionally stable again.

Preferably, the thermoplastic layers are embodied or formed as films. Therefore, these plastic layers can be relatively thin. The films can have a thickness in the range of 0.01 to 2 mm. It is often favorable to select the films to be not very thick, so that the proportion of the reinforcing fibers is comparatively large. A good ratio between mass and tensile strength can be achieved in this manner.

Preferably, the layers are connected to one another by spaces between the fibers. This results in an even better coherence. Although in principle a connection between an upper layer with the reinforcing fibers and a lower layer with the reinforcing fibers is sufficient to produce the semi-finished product, an additional coherence results when the two layers can be connected to one another by spaces between fibers. Furthermore, the reinforcing fibers are better protected from lateral displacement.

Preferably, reinforcing fibers with a single alignment are arranged between two layers of plastic. A particularly good tensile strength is then produced in the direction of this alignment. The semi-finished product is particularly loadable in this direction.

Preferably, the reinforcing fibers are embodied or formed as glass fibers, carbon fibers, mineral fibers, ceramic fibers, plastic fibers or natural fibers or as a mixture of these fibers. Depending on the desired use, reinforcing fibers of this type can provide an adequate tensile strength and dimensional stability of a component produced from the semi-finished product.

Preferably, the reinforcing fibers can be of the same material as the thermoplastic material, and such reinforcing fibers may have a higher melting point and/or a higher tensile strength than the plastic of the layers. This makes it easier to reuse or recycle the semi-finished product. In this way, the semi-finished product can be, e.g., remelted or even entirely melted, since the reinforcing fibers, too, would disappear in the melt and, therefore, not interfere with the reuse or recycling of the product.

Preferably, the plastic is selected from a group of plastics containing polypropylenes, polyamides, polyphenyl sulfides, polyether ketones, polyether ether ketones and polyethylenes. Plastics of this type are available at low cost. They meet prerequisites for use for components in many fields.

Embodiments also relate to a semi-finished product composite with at least two semi-finished products of this type that are placed one on top of the other and connected to one another. A single semi-finished product has a comparatively small thickness of, e.g., 0.2 mm or less. In some cases, a semi-finished product of this type is not loadable enough. In such a case, two or more semi-finished products can be stacked one on top of the other and connected to one another, e.g., through compression and/or with heat input. The strength properties of the individual semi-finished products are thus added together.

It may be preferable that the reinforcing fibers of different semi-finished products have different directions. The tensile strength of the semi-finished product composite can then be increased in several directions.

According to embodiments, a method is provided for producing a semi-finished product of plastic and reinforcing fibers in which the reinforcing fibers are arranged between two layers of thermoplastic material.

An approach of this type can be automated relatively easily so that the semi-finished product can also be produced cost-effectively.

It may also be preferable that the fiber strands are spread out transversely to their longitudinal extension and inserted between the layers of the thermoplastic material. Many fibers, e.g., carbon fibers, are sold in fiber strands in which several thousand individual fibers are combined. A fiber strand can contain, for example, 12000, 24000, 48000 or even 240000 individual fibers. The more fibers a fiber strand contains, the more cost-effective the fiber strand as a rule. The fiber strands usually have a circular or elliptical shape in cross section. Therefore before the fibers can be inserted between the plastic layers, the fiber strands are spread out transversely to their longitudinal direction in order to thus form so-called fiber strips. The fiber strips are then arranged next to one another, in order to form a unidirectional fiber layer. This unidirectional fiber layer is then inserted between the plastic layers. The production of the unidirectional fiber layer can be carried out quasi-continuously.

In the production of the unidirectional fiber layer, the individual fiber strands are preferably spread out according to the required surface properties of the unidirectional fiber web according to layer thickness and weight per unit area. The adjustment of the weight per unit area of the unidirectional fiber web is thereby preferably coordinated with the surface properties of the plastic layer, in particular the film thickness, such that a defined fiber mass content or fiber volume content is achieved in the subsequent fiber reinforced plastic semi-finished product. To this end, the individual fiber rovings or fiber strands are to be spread out to a predetermined width, in particular according to the number of individual fibers contained, and combined to form a flat unidirectional fiber web of then likewise defined width. The unidirectional fiber web running in the production direction is embedded with the surface properties predefined through the spreading of the individual fiber strands between the plastic layers fed to the unidirectional fiber web from both sides.

Preferably, the plastic layers are unwound from rolls for this purpose. This means that the method can be carried out in a quasi-continuous manner. The unidirectional fiber layer of spread out fiber strands can be fed in an endless manner. The plastic layers can also be fed in an endless manner.

Preferably, the plastic layers bearing on the unidirectional fiber layer are acted on with pressure and/or increased temperature. This can be carried out, e.g., by a pair of pressure rolls, which are pressed against one another with a certain force. The thickness of the semi-finished product can be adjusted within given limits in the roll gap or nip of a pair of pressure rolls of this type. As a result of the increased temperature a softening of the plastic layers results, so that the reinforcing fibers can penetrate into the plastic somewhat and the plastic can connect through gaps or openings between reinforcing fibers to the plastic of the other layer.

Preferably, the semi-finished product produced, that is, the connected plastic layers with reinforcing fibers lying therebetween, are wound up to form a reel. A semi-finished product is thereby obtained in the form of a roll from which virtually any lengths can be cut in order to form components therefrom.

Embodiments of the invention are directed to a semi-finished product that includes reinforcing fibers and two layers of thermoplastic material. The reinforcing fibers are arranged between the two layers of thermoplastic material.

In accordance with features of the embodiments, the two layers can be formed as films.

According to other features of the embodiments, the two layers can be connected to one another in spaces located between the reinforcing fibers.

Aspects of the embodiments can include that the reinforcing fibers are arranged in a unidirectional alignment between the two layers of plastic.

Moreover, the reinforcing fibers can include at least one of glass fibers, carbon fibers, mineral fibers, ceramic fibers, aramide fibers, plastic fibers and natural fibers.

Still further, the reinforcing fibers can be formed of a same material as the thermoplastic material and have at least one of a higher melting point and a higher tensile strength than the thermoplastic material.

In other aspects of the embodiments, the plastic can include at least one of polypropylenes, polyamides, polyphenyl sulfides, polyether ketones, polyether ether ketones and polyethylenes.

According to further aspects of the embodiments, a semi-finished product composite can include at least two of the above-described semi-finished products, and the at least two semi-finished products can be connected together one on top of the other.

According to feature of the embodiments of the invention, the reinforcing fibers of the at least two semi-finished products may be arranged in different directions.

Embodiments of the instant invention are directed to a method for producing a semi-finished product of plastic and reinforcing fibers. The method includes arranging the reinforcing fibers between two layers of thermoplastic material.

In accordance with further embodiments of the present invention, the method can include spreading out fiber strands transversely to their longitudinal extension, and inserting the spread out fiber strands between the layers as the reinforcing fibers. The method can also include unwinding the thermoplastic layers from rolls.

According to other aspects of the embodiments of the invention, the reinforcing fibers can be unidirectionally oriented, and the method may further include acting on the layers with at least one of pressure and increased temperature.

Aspects of the embodiments can also include winding up the thermoplastic layers with the reinforcing fibers lying therebetween.

Embodiments of the invention are directed to an apparatus for forming a semi-finished product. The apparatus includes a fiber strand supply structure structured and arranged to contain a plurality of fiber strands, and a delivery device structured and arranged to draw the plurality of fiber stands from the fiber strand supply structure. A thermoplastic sheet supply is structured and arranged to supply two thermoplastic sheet layers, and a joining unit is structured and arranged to join the drawn plurality of fiber strands between two thermoplastic sheet layers.

According to aspects of the embodiments, the fiber strand supply structure may include a creel structured and arranged to store a plurality of bobbins.

According to other aspects of the embodiments, the fiber strand supply structure can include a supply roll on which the plurality of fiber strands is wound.

Features of the embodiments of the invention can further include a spreading device structured and arranged to space apart the drawn plurality of fiber strands to form gaps between adjacent fiber strands and to position the plurality of fiber stands in a same layer. In the gaps formed between the adjacent fiber strands, the joining unit may join the two thermoplastic sheet layers together.

In accordance with still yet other embodiments of the present invention, a winding device can be structured and arranged to wind up the plurality of fiber strands joined between the two thermoplastic sheet layers.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a device for producing a semi-finished product; and

FIG. 2 diagrammatically illustrates the structure of the semi-finished product.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied or formed or formed in practice.

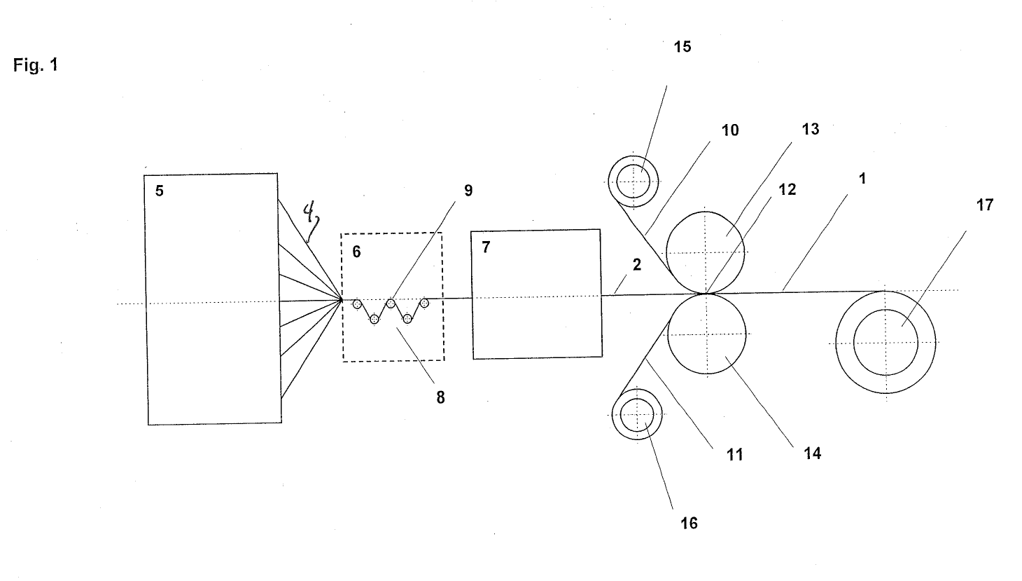

FIG. 1 illustrates a device for producing a semi-finished product 1, which is embodied or formed as fiber reinforced plastic.

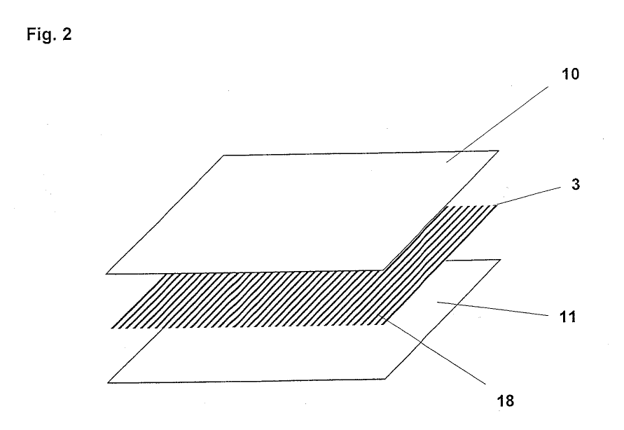

To this end, a unidirectional fiber layer 2 is produced from reinforcing fibers, in a manner by which individual fiber strands 4 are drawn off from a supply arrangement 5 and spread out and combined in a spreading device 6 to form unidirectional fiber layers 2 with defined width and basis weight. All of the reinforcing fibers 3 (see FIG. 2), which can be an individual fiber strand 4, an individual fiber that forms a part of the individual fiber strand 4, or a fiber strip (discussed below), have the same alignment in a unidirectional layer, which preferably run in a longitudinal direction of the semi-finished product. In order to produce unidirectional layer 2, several individual fiber strands 4 are drawn out of supply arrangement 5. Supply arrangement 5 is formed, for example, by a creel that contains several bobbins on which individual fiber strands 4 are wound up.

Fiber strands 4 are drawn off by a delivery device 7 and guided over spreading device 6 under a certain tensile stress over an arrangement 8 of rods 9. When running through the spreading device 6, an individual fiber strand 4 that is composed of a plurality of individual fibers is processed in such a manner that the individual fibers that are further away from a respective rod 9 try to run closer to the rod 9. These individual fibers thereby displace laterally outwards the individual fibers arranged nearer to the corresponding rod 9, which results in a spreading of the individual fibers of individual fiber strands 4 to form strips. The individual fibers in the formed fiber strips can be in contact with adjacent fibers or these fibers can be spaced from each other. The formed strips can then be arranged to lie next to one another in a spaced manner to form unidirectional fiber layer 2.

Unidirectional fiber layer 2 is guided jointly with two films 10 and 11 through a roll gap or nip 12 formed between rolls 13 and 14. An increased temperature is produced in nip 12. For example, one of the two rolls 13 and 14 or also both of the rolls 13 and 14 can be heated for this purpose. The two rolls 13 and 14 are pressed with a predetermined pressure against one another so that the two films 10 and 11 with the unidirectional fiber layer 2 lying between them are connected to form the fiber reinforced semi-finished product.

Films 10 and 11 are unwound from respective supply rolls 15 and 16. Semi-finished product 1 is wound up on a roll 17 after running through nip 12.

Films 10 and 11 are formed from a thermoplastic material, e.g., polypropylenes, polyamides, polyphenyl sulfides, polyether ketones, polyether ether ketones or polyethylenes. These plastics soften at a higher temperature and become solid again when the temperature drops. Accordingly, when required, semi-finished product 1 can be unwound from roll 17 and cut to the required length. It can subsequently be placed in a mold and shaped with an application of heat and pressure. A shaping of this type is similar to a deep drawing of a metal sheet so that semi-finished product 1 can be shaped in a similar manner to a metal sheet.

Unidirectional fiber layer 2 can also be unwound directly from a supply roll.

Glass fibers, carbon fibers, mineral fibers, ceramic fibers, aramide fibers or natural fibers are possible as reinforcing fibers. Plastic fibers can also be used which are composed of the same material as films 10 and 11 but have a higher melting point and/or a higher tensile strength. An embodiment of this type facilitates recycling.

In the end, a semi-finished product 1 is produced in which reinforcing fibers 3 are embedded between two films 10 and 11 of thermoplastic material. Between fibers 3 are small gaps 18 within which the two films 10 and 11 can be connected to one another. The connection between films 10 and 11 and reinforcing fibers 3 is thereby virtually indissoluble.

If the strength of a semi-finished product 1 with one layer is not sufficient, several layers of semi-finished product 1 can easily be arranged one on top of the other and connected to one another with the application of increased pressure and increased temperature to produce a semi-finished product composite. For example, a press can be used for this purpose.

If several layers of semi-finished product 1 are arranged one on top of the other, it can be favorable to use different layers of semi-finished product 1 with different fiber directions. In this case, a semi-finished fiber composite is produced with an improved tensile strength in several directions.

The production process shown can run in a quasi-continuous manner. Interruptions occur only when rolls 15 and 16 are empty or the bobbins on which the individual fiber strands 4 are wound have to be replaced.

The required lengths of films 10 and 11 and of the fiber strands 4 can be estimated in advance and the size of rolls 15 and 16 and the size of the rolls with fiber strands 4 can be coordinated with one another such that they become empty at approximately the same time. In this case, only a single interruption is necessary in order to replace all of the supply rolls.

Through the layered structure of semi-finished product 1 in which reinforcing fibers 3 are arranged between two layers of thermoplastic material, an excellent protection for reinforcing fibers 3 results. In particular, the danger of fiber breakages is relatively low. A predetermined tensile strength in the direction of the reinforcing fibers can also be retained even after a few shaping operations.

The shaping temperature for shaping semi-finished product 1 is above the service temperature of the subsequent component produced from semi-finished product 1, e.g., in the range of 200° to 400° C. Accordingly, there is no danger of component failure of the component produced from semi-finished product 1 under the service temperature as a result of the application of temperature.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A semi-finished product comprising:
reinforcing fibers; and
two layers of thermoplastic material,
wherein the reinforcing fibers are arranged between the two layers of thermoplastic material.

2. The semi-finished product in accordance with claim 1, wherein the two layers are formed as films.

3. The semi-finished product in accordance with claim 1, wherein the two layers are connected to one another in spaces located between the reinforcing fibers.

4. The semi-finished product in accordance with claim 1, wherein the reinforcing fibers are arranged in a unidirectional alignment between the two layers of plastic.

5. The semi-finished product in accordance with claim 1, wherein the reinforcing fibers comprise at least one of glass fibers, carbon fibers, mineral fibers, ceramic fibers, aramide fibers, plastic fibers and natural fibers.

6. The semi-finished product in accordance with claim 1, wherein the reinforcing fibers are formed of a same material as the thermoplastic material and have at least one of a higher melting point and a higher tensile strength than the thermoplastic material.

7. The semi-finished product in accordance with claim 1, wherein the plastic comprises at least one of polypropylenes, polyamides, polyphenyl sulfides, polyether ketones, polyether ether ketones and polyethylenes.

8. A semi-finished product composite comprising at least two semi-finished products in accordance with claim 1, wherein the at least two semi-finished products are connected together one on top of the other.

9. The semi-finished product composite in accordance with claim 8, wherein the reinforcing fibers of the at least two semi-finished products are arranged in different directions.

10. A method for producing a semi-finished product of plastic and reinforcing fibers, comprising:
arranging the reinforcing fibers between two layers of thermoplastic material.

11. The method in accordance with claim 10, further comprising:
spreading out fiber strands transversely to their longitudinal extension; and
inserting the spread out fiber strands between the layers as the reinforcing fibers.

12. The method in accordance with claim 11, further comprising unwinding the thermoplastic layers from rolls.

13. The method in accordance with claim 10, wherein the reinforcing fibers are unidirectionally oriented, and the method further comprises acting on the layers with at least one of pressure and increased temperature.

14. The method in accordance with claim 10, further comprising winding up the thermoplastic layers with the reinforcing fibers lying therebetween.

15. An apparatus for forming a semi-finished product, comprising:
a fiber strand supply structure structured and arranged to contain a plurality of fiber strands;
a delivery device structured and arranged to draw the plurality of fiber stands from the fiber strand supply structure;
a thermoplastic sheet supply structured and arranged to supply two thermoplastic sheet layers; and
a joining unit structured and arranged to join the drawn plurality of fiber strands between two thermoplastic sheet layers.

16. The apparatus in accordance with claim 15, wherein the fiber strand supply structure comprises a creel structured and arranged to store a plurality of bobbins.

17. The apparatus in accordance with claim 15, wherein the fiber strand supply structure comprises a supply roll on which the plurality of fiber strands is wound.

18. The apparatus in accordance with claim 15, further comprising a spreading device structured and arranged to space apart the drawn plurality of fiber strands to form gaps between adjacent fiber strands and to position the plurality of fiber stands in a same layer.

19. The apparatus in accordance with claim 18, wherein, in the gaps formed between the adjacent fiber strands, the joining unit joins the two thermoplastic sheet layers together.

20. The apparatus in accordance with claim 15, further comprising a winding device structured and arranged to wind up the plurality of fiber strands joined between the two thermoplastic sheet layers.
